(19) United States
(12) Patent Application Publication
(10) Pub. No.: US 2005/0021394 A1
(43) Pub. Date: Jan. 27, 2005

(54) Method and system for distributing multimedia object

(76) Inventors: Folkert Gaayo Miedema, Eindhoven (NL); Jakobus Middeljans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,832

(22) PCT Filed: Dec. 16, 2002
(86) PCT No.: PCT/IB02/05545

(30) Foreign Application Priority Data
Jan. 22, 2002 (EP) 02075256.4

(51) Int. Cl. G06F 17/60

(52) U.S. Cl. 705/14

(57) ABSTRACT

Methods of and system for distributing a multimedia object (212). A server (201) receives a request to buy the multimedia object (212) from a client device (101). After authorizing the request, an identifier for the object (212) is forwarded to a file sharing network (100). A node (102) that is able to distribute the object (212) to the client (101) signals a positive response to the server (201) and subsequently transmits the object (212) to the client (101). The operator of the node (102) is then rewarded for distributing the object (212) in this fashion. This way the server (201) does not have to distribute the object (212) itself, but still earns money from the operator of the client (101). By encrypting or otherwise protecting the object (212) it is prevented that clients share the objects directly without contacting the server (201).

The invention relates to a method of distributing a multimedia object, in which a client device downloads the multimedia object from a distributing server.

The invention further relates to a method of and a system for enabling distribution of a multimedia object.

The invention further relates to a client for use in such a system.

Electronic music distribution, but also electronic distribution of other types of multimedia objects, faces several technical and challenges. In its most basic form, a distributing server is connected to a network such as the Internet. An often large number of multimedia objects is made available from this distributing server to client devices also connected to this network.

Multimedia objects are quite large, typically in the order of several megabytes, and many requests for downloading these objects can be expected. This places a heavy burden on the server, and requires for a large capacity—and thus expensive—network connection. As the server can receive requests from clients all over the world, it is to be expected that a lot of long-distance transmissions are necessary. These transmissions (e.g. over transatlantic datacommunication lines) are very expensive.

Often multiple physical server systems, connected to the network with redundant connections are necessary. It will be evident that this means large costs for the operator of the distribution server, and additionally introduces complex technical requirements to maintain the system under the heavy load.

It is an object of the invention to provide a method of distributing according to the preamble, which reduces the load on the distributing server while allowing the same number of clients to obtain the multimedia object.

This object is achieved according to the invention in a method in which the client device is connected to a peer-to-peer file sharing network and redistributes the multimedia object over the peer-to-peer file sharing network, for which redistributing the operator of the client device is given a reward.

Because the client device redistributes the multimedia object over the file sharing network, other nodes in that network no longer need to obtain the object from the central server. This way, the load on the server is reduced even though the same number of clients can still obtain the multimedia object. Additionally, the nodes in the file sharing network will be close to each other network-wise or geographically. This reduces the costs of transmission of the object from one node to another. The central server does not have to transmit the multimedia object multiple times to multiple nodes on the file sharing network, but only once to one node, reducing the need for repetitive transmission.

In an embodiment the method further comprises keeping track of the number of times that the client device redistributes the multimedia object over the peer-to-peer file sharing network, and rewarding the operator of the client device in dependence on said number of times.

In a further embodiment the reward constitutes at least one of a discount on a price normally paid for downloading a multimedia object from the distributing server, a number of points for use in a bonus system, an electronic coupon, a permission to download one or more further multimedia objects from the distributing server, metadata related to the multimedia object, and a ticket for an appearance of the performer(s) of the multimedia object. Such rewards are known to be of interest to people, so it is advantageous to offer them here in return for redistributing a particular multimedia object.

In a further embodiment the method further comprises obtaining an identifier for the operator of the client device before distributing the multimedia object and embedding the identifier in the multimedia object by means of a watermark before the client device downloads the multimedia object.

A technical aspect of the method according to the invention is how to determine which particular operator redistributed a particular multimedia object over the file sharing network, so that this operator can be rewarded. This embodiment provides an advantageous way of determining this. By using watermarking technology, the identifier is hidden in the multimedia object, difficult or next to impossible to remove and yet the perceptual quality of the multimedia object is not affected.

It is now possible to detect the watermarked identifier in a multimedia object made available in the file sharing network. For instance, a file sharing client that downloads the multimedia object can be equipped with a watermark detector which obtains the identifier from the object. The identifier can then be forwarded to an accounting server, which keeps track of the redistributing taking place in the file sharing network.

It is a further object of the invention to provide a method of enabling distribution of a multimedia object, which reduces the load on the distributing server while allowing the same number of clients to obtain the multimedia object.

This object is achieved according to the invention in a method which comprises receiving a request for the multimedia object from a client device, forwarding the request to a file sharing network, receiving an indication from a node in the file sharing network indicating that the node is able to distribute the multimedia object to the client device, and rewarding an operator of the node for said distributing. As the multimedia object is now distributed by a node in the file sharing network rather than by the central server, the load on the central server is now clearly reduced.

Because nodes in the file sharing network are rewarded for distributing objects in this fashion, they are encouraged to assist in the method of the invention. Suitable rewards are set out above.

In an embodiment the method further comprises authorizing the request before forwarding the request to the file sharing network. This has the advantage that a verification can be made as to whether the client device is allowed to obtain the multimedia object.

Preferably, a payment is obtained from an operator of the client device, so that the server operator can make money by enabling distribution in this fashion. Alternatively, the existence of a subscription by the operator of the client device could be checked, a blacklist could be used to verify that the client device acts legitimately, and so on.

In a further embodiment the request is forwarded by obtaining a fingerprint for the multimedia object and submitting a query comprising the fingerprint to a node in the file sharing network. A fingerprint of a multimedia object is a representation of the most relevant perceptual features of the object in question. Such fingerprints are sometimes also known as “(robust) hashes”. The fingerprints of a large number of multimedia objects along with their associated respective metadata, such as the title, artist, genre and so on, are stored in a database.

The metadata of a multimedia object is retrieved by computing its fingerprint and performing a lookup or query in the database using the computed fingerprint as a lookup key or query parameter. The lookup then returns the metadata associated with the fingerprint.

An example of a method of computing such a fingerprint is described in European patent application number 01201505.4 (attorney docket PHNL010110), as well as in Jaap Haitsma, Ton Kalker and Job Oostveen, “Robust Audio Hashing For Content Identification”, International Workshop on Content-Based Multimedia Indexing, Brescia, September 2011.

Using fingerprints rather than metadata (e.g. the title and artist) of the multimedia object has the advantage that incorrect metadata can no longer prevent the object from being found on the file sharing network. Nodes only need to compare the fingerprint of the query with a list of fingerprints for objects they are sharing to determine whether they have the object or not, and if so they can send the indication to the central server.

It is a further object of the invention to provide a system according to the preamble, which reduces the load on the distributing server while allowing the same number of clients to obtain the multimedia object.

This object is achieved according to the invention in a system which comprises a distributing server arranged for receiving a request for the multimedia object from a client device and for forwarding the request to a file sharing network, and an accounting server for receiving an indication from a node in the file sharing network indicating that the node is able to distribute the multimedia object to the client device, and rewarding an operator of the node for said distributing.

It is a further object of the invention to provide a client device for use in the system of the invention, which client device comprises a tracking module arranged for keeping track of the number of times that the client device redistributes the particular multimedia object over the peer-to-peer file sharing network, and for transmitting said number of times to an accounting server.

These and other aspects of the invention will be apparent from and elucidated with reference to the embodiments shown in the drawing, in which:

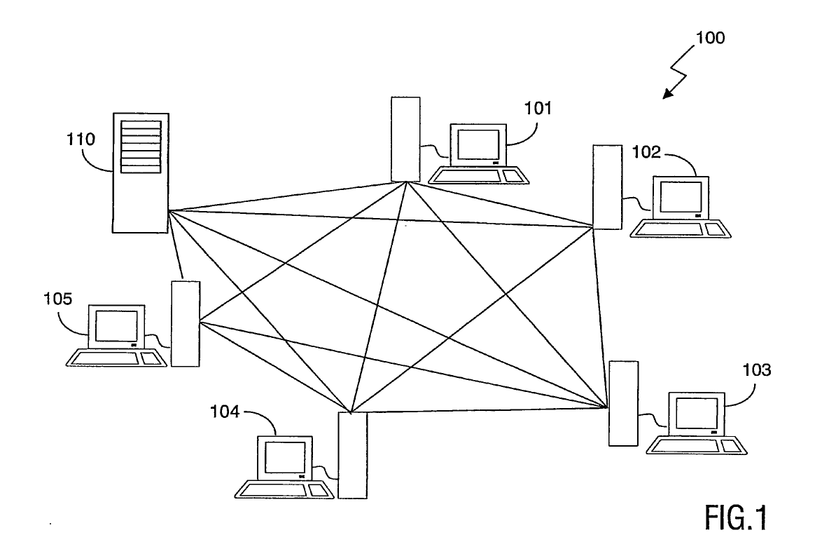

FIG. 1 schematically shows a file sharing network comprising plural clients;

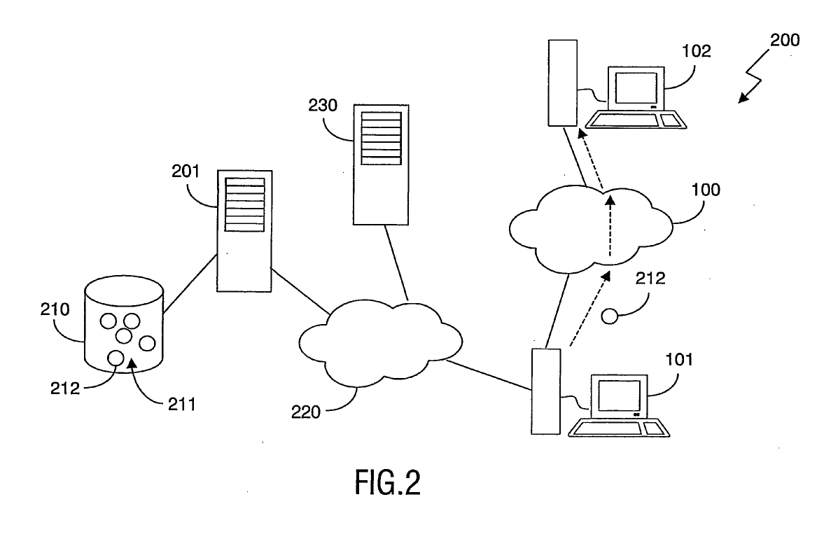

FIG. 2 schematically shows a system comprising a distributing server arranged for the distribution of multimedia objects to client devices;

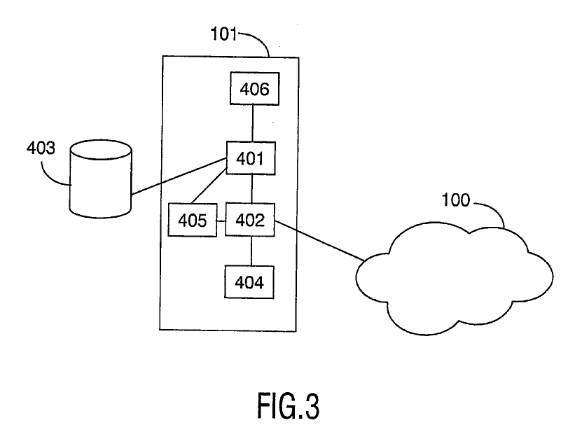

FIG. 3 shows a file sharing client in more detail.

Throughout the figures, same reference numerals indicate similar or corresponding features. Some of the features indicated in the drawings are typically implemented in software, and as such represent software entities, such as software modules or objects.

FIG. 1 schematically shows a file sharing network 100 comprising plural file sharing clients 101, 102, 103, 104 and 105. Although shown here as a physical network, with direct connections between the clients 101-105, the network 100 is best regarded as a conceptual or virtual network. That is, it is not necessary that all clients 101-105 are physically or network-wise directly connected to each other all the time. All that is needed is that one client “on the network” can obtain files or objects from another client. Also, even when direct client-to-client connections are used, it is not necessary that all clients be connected to all other clients.

The network 100 may comprise a server 110, which performs a directory service for the clients 101-105. To connect to the file sharing network 100, a client 101 submits a list of the files (or objects) it wants to share to the server 110. The server 110 combines the lists it receives from all the clients connected to the network 100. Other clients 102-105 can then connect to the server 110 and browse the combined list or search for specific objects on the list. They can subsequently contact the client that has the object they are looking for, and obtain (download) it from that client directly. This way, the server 110 does not directly participate in the sharing of files or objects between the clients 101-105. This approach is well known in the worldwide Napster file sharing network.

It is also possible to realize the network 100 without the server 110. In that case, a client 101 connects to the network 100 by connecting to one or more other clients 102-105 that are already on the network 100. A client searches the network by sending a search request to the clients it is connected to. These clients examine their list of objects which they share, and return a result if the requested object is in that list. Furthermore, the request is forwarded to other clients connected to these clients. This way, the request is distributed throughout the entire network 100 until it is received by a client which can fulfill it, or until all clients have received it and none are able to fulfill it.

Such an embodiment is known from e.g. the Gnutella file sharing network. A disadvantage of this embodiment is that the network 100 is not scalable. Gnutella like networks currently for example cannot support 1 million clients. Furthermore the network becomes slow if there are a number of “slow” computers, i.e. computers with limited bandwidth to the network 100, processing power and/or memory.

Alternatively the client 101 can, after connecting to the one or more other clients 102-105, submit its list of files or objects it wants to share to those other clients 102 -105. The list is then passed on to all the clients on the network 100. This way, all clients know which clients have which files or objects available, and can contact that client directly.

The known KaZaa file sharing network also operates without a server 110, but to overcome the above-mentioned problem uses two types of clients: a super node and a “normal” client. Super nodes are clients which have sufficient bandwidth, processing power and memory. A normal client connects to the network by connecting to a super node and sends the list of the files to be shared to the super node. A super node has connections to a number of clients and furthermore is also connected to a number of other super nodes.

A super node is at the same time also a normal client. That is, for the user the fact that his computer is a super node is transparent. When a user wants to search for a file, his client sends a request to the super node(s) to which his client is currently connected. The super nodes return the matching files, that are in the lists send by their clients. Furthermore the super node forwards the request, if necessary, to all the super nodes to which it is connected in a fashion similar to the one described above in the Gnutella embodiment. However, since the connections between super nodes have a large bandwidth this approach is much faster than the Gnutella networks. Furthermore it can be scaled up to millions of clients.

Such file sharing networks, typically referred to as peer-to-peer or P2P file sharing networks, have an enormous popularity. Well known examples of these networks are: Napster, Musiccity, Gnutella, KaZaa, Imesh and Bearshare. Once users have installed the appropriate client software on their personal computers, they can share their files and they are able to download files shared by other users. The clients 101-105 may be connected to a network such as the Internet, which facilitates the establishment of the file sharing network 100. A client could e.g. use a direct TCP/IP connection to another client to obtain a file or object.

On the most popular networks, usually over 500,000 people are connected simultaneously. At the time of writing, people are mostly sharing music files (often in the MP3 format), but the sharing of movies is gaining popularity. The term “multimedia object” will be used to denote files containing music, songs, movies, TV programs, pictures and other types of binary data, but also textual data can be shared in this fashion. It is to be noted that a multimedia object may be made up of several different files.

FIG. 2 schematically shows a system 200 comprising a distributing server 201 arranged for the distribution of multimedia objects 211 to client devices like client 101. The multimedia objects 211 are stored in a storage medium 210. The client 101 can communicate with the server 201 using a network 220 such as the Internet.

When the client 101 sends a request to download a particular multimedia object 212 to the server 201, the server 201 can simply read the particular multimedia object 212 from the storage 210 and transmit a copy it to the client 101. The server 201 can be used to sell music electronically. In that case, the server 201 can request an electronic payment from the client 101 before or after transmitting the copy. However, this has the disadvantage that the server 201 is now responsible for transmitting the particular multimedia object 212, which may impose large costs for transmission on the operator of the server 201.

To avoid these costs, the server 201 instead forwards the request to a node in the file sharing network 100. Preferably this node is a super node, if the file sharing network 100 makes use of super nodes. The server 201 should authorize the operator of the client 101 before forwarding the request, e.g. by requesting a username and password from the client 101. Based on the authorization, the server 201 can charge an account or credit card of the operator of the client 101 for a certain amount of money. It could also send a bill to the operator. Also gift certificates, electronic coupons, bonus points from an electronic points scheme and so on could be used as payment for the multimedia object 212 requested by the operator.

The request is preferably forwarded by obtaining a fingerprint for the multimedia object 212 and submitting a query comprising the fingerprint to a node in the file sharing network 100. As explained above, a fingerprint of a multimedia object is a representation of the most relevant perceptual features of the object in question. This makes it possible to identify multimedia objects by comparing their fingerprints with a fingerprint comprised in a particular query, regardless of the metadata which the clients on the file sharing network 100 may have associated with the objects it is sharing.

The node receiving the request tries to fulfill it by searching for the particular multimedia object on the file sharing network 100. If another node, for instance client device 102, responds to the request and transmits the particular multimedia object 212 to the client device 101, it should also signal the server 201 to notify it of this fact.

The operator of the client 102 is subsequently rewarded for the act of redistributing the downloaded multimedia object 212 over the file sharing network 100 to client 101. A variety of rewards can be used. For example, the reward can constitute a discount on a price normally paid for downloading a multimedia object from the distributing server 201. This way, the operator of a client device saves money when buying multimedia objects from the server 201 and redistributing said objects on the file sharing network 100.

Alternatively, the reward can constitute a number of points for use in a bonus system or an electronic coupon. While not the same as price discounts or money, such rewards can also be attractive if the bonus points or electronic coupons can be exchanged for some valuable commodity.

The reward can also constitute a permission to download one or more further multimedia objects from the distributing server 201. This provides a direct incentive to the operator to redistribute a downloaded multimedia object to others on the file sharing network 100. Having done so, he immediately can get access to more multimedia objects.

The reward can also constitute metadata related to the downloaded multimedia object, for instance the lyrics to a song contained in the object, photos or videos of the performer(s) of the multimedia object, access to a restricted area of the Website of the performer(s), and so on. Such metadata is often desirable yet hard to obtain, so making it available as a reward provides a nice incentive to operators of file sharing clients.

The reward can also constitute a ticket for an appearance of the performer(s) of the multimedia object, e.g. a concert or other live performance, a performance in a television show, or a live chat session with the performer(s). Many other rewards are of course also possible.

If the request cannot be fulfilled by any of the nodes on the file sharing network 100, the node that initially received the request from the server 201 should report this fact back to the server 201. This can be done when almost report that they do not have the requested multimedia object, when it takes too long before any response arrives, or for any other reason. Having received such a negative response, the server 201 now must fulfill the request from the client 101 for the storage 210. This may mean a transatlantic transmission of the particular multimedia object 212 from the server 201 to the client 101, with the associated high transmission costs.

As the client 101 is also connected to the file sharing network 100, it is now possible for the operator of the client 101 to redistribute the downloaded multimedia object 212 over the file sharing network 100. This way, the other clients 102-105 connected to the file sharing network 100 can also obtain a specimen of the downloaded multimedia object 212. It is observed that the file sharing network 100 and the network 220 could overlap in whole or in part.

If the client 101 now in fact redistributes the multimedia object 212 over the file sharing network 100, the operator of the client 101 will now be rewarded for such redistributing. This way, the operator is encouraged to engage in such redistribution. Further, if now other clients, such as client 102, request the particular multimedia object 212 from the server 201, the request will be forwarded to the file sharing network 100 where client 101 is able to fulfill it. The server 201 now no longer needs to serve the other client 102 from its own storage 210, reducing its average network requirements.

Preferably, the reward is only given in dependence on the number of times that the client 101 redistributes the downloaded multimedia object 212 over the peer-to-peer file sharing network 100. In this embodiment there must be some entity that keeps track of this number of times.

The keeping track can be performed by a tracking module in the client device 101. This has the advantage that it gives the most reliable figures on the number of times that the multimedia object has been redistributed, as the tracking module can directly monitor all redistributions performed by the client 101.

Preferably the tracking module is realized as a software module, e.g. a plug-in, to be used in conjunction with the software that realizes the file sharing functionality of the client 101. This has the advantage that it can be made available separately, and that users can add this functionality by downloading the software module and installing it. Registration can be required before the software can be downloaded, so that later on the operator can be identified based on this registration.

The keeping track can also be performed by the directory server 110 in the peer-to-peer file sharing network 100, or by a super node in the file sharing network 100. This has the advantage that it is more difficult for individual users to tamper with the results of this keeping track. A software module in a computer under the control over the operator can of course be tampered with, if insufficient security measures are taken or the protection mechanism is broken or circumvented.

A limitation to the number of times that the reward is given to one particular operator may advantageously be put in place. This way, the incentive to artificially inflate the number of times that a particular multimedia object has been redistributed (in order to get many rewards) is reduced. In particular, the number of times can be chosen as one, so that only the first time a multimedia object is redistributed is reason for an award.

In the embodiment of FIG. 2 there is an accounting server 230 that keeps track of the number of times that particular clients 101-105 redistributed particular multimedia objects in the peer-to-peer file sharing network 100. The distributing server 201 could also perform the role of accounting server.

When the server 201 identifies the operator of the client 101 before transmitting the multimedia object to the client 101, there is another way to keep track of the number of times the multimedia object was redistributed by the operator of the client 101.

Before transmitting the requested multimedia object to the client 101, the server 201 embeds an identifier for the client 101 or for the operator of the client 101 into the multimedia object preferably by means of watermarking technology, although other ways are of course also possible. This way, the identifier is hidden in the multimedia object, difficult or next to impossible to remove and yet the perceptual quality of the multimedia object is not affected.

The watermarked multimedia object is subsequently transmitted to the client 101, which redistributes it over the peer-to-peer file sharing network 100. Other clients 102-105 are in this embodiment equipped with a watermark detector. Using this detector, the other client 102 detects the watermark and extracts the identifier, which it forwards to the accounting server 230.

This way, the accounting server 230 knows that the multimedia object was redistributed by the client 101, as it contains the identifier for client 101, and that identifier was submitted by client 102. It is reasonable to assume that client 102 obtained the multimedia object via the file sharing network 100, especially when the client 102 together with the identifier transmits a version number of its file sharing software or something similar.

The specimen of the particular multimedia object 212 distributed by the client 101 does not have to be the same specimen originally distributed by the server 201. The client 101 could make the multimedia object 212 available from another source, such as a CD or other record carrier. However, if the specimen in question represents the multimedia object requested by another client, the request can be fulfilled just as well by transmitting the specimen from the client 101 to the other client. The other client still gets the object it requested, and the server 201 does not needs to transmit its specimen to the other client. Thus, it is still justified to reward the operator of the client 101 for his distributing.

Using this particular approach, the need for the server 201 to maintain storage 210 is greatly reduced and might even be obviated altogether. The server 201 then acts more like a clearinghouse for payments for access to multimedia objects than as a distribution service.

In this embodiment the multimedia objects 211 are preferably made available from the server 201 in a secure fashion. For instance, the objects can be distributed in an encrypted format, whereby software on the receiving device will permit playback but not storing in unencrypted form. One technology for securing content items is the Intertrust “Digifile” technology, known from e.g. U.S. Pat. No. 5,892,900. Other technologies for securing multimedia objects can of course also be used.

According to U.S. Pat. No. 5,892,900, music is stored in a secure digital container, called the Digifile. The receiver must obtain a license file from a license server. This license file provides a set of permissions, for example permission to play back the music, or permission to store the multimedia object on a storage medium. The user of course has to pay a certain amount of money for each permission. The receiver now contacts the server 201 to make this payment and receives the above-mentioned authorization in return. The authorization comprises said license file.

The license file also contains a decryption key or other information required to access the music inside the Digifile. When the recipient has obtained a license, it can decrypt the music and play it to the user. The user can distribute the Digifile to others, but these others cannot decrypt the music without buying their own license file. Thus, these others are required to contact the server 201 as well. The user who distributed the Digifile to others will be rewarded as above, so he has the necessary incentive to distribute them.

If the multimedia objects are made available on the server 201 in a secure fashion, and the server 201 watermarks the multimedia objects it transmits to a client device with an identifier for that client device, it becomes even easier to keep track of the number of times that individual multimedia objects are transmitted by client 101 to other clients 102-105 on the file sharing network 100.

As explained above, if the multimedia objects are made available in a secure fashion, devices need a license file of some sort in order to be able to render the multimedia objects. This means that if client 101 obtains a multimedia object from the server 201, and subsequently client 102 obtains that multimedia object from client 101, client 102 needs to obtain such a license file.

Client 102 now first detects the watermark and extracts the identifier, like was set out above. Client 102 then sends a request for a license file to a license server, and sends the identifier to the accounting server 230. Preferably these two servers are embodied as a single licensing and accounting server 230. The server 230 now knows from the identifier that client 102 obtained the multimedia object from client 101, and from the request for a license file that the multimedia object was made available in a secure fashion. The latter fact indicates that this multimedia object must have been obtained from the server 201, so it is now clear that it was client 101 which obtained the multimedia object from the server 201 and redistributed it in the file sharing network 100. Hence, the operator of client 101 should get the reward.

FIG. 3 shows the file sharing client 101 in more detail. The file sharing client 101 is preferably realized as a personal computer on which file sharing software 401 is running, as is well-known in the art. The file sharing software 401 typically makes use of a networking module 402, such as the TCP/IP stack available in modern operating systems.

A storage 403 contains one or more multimedia objects which are shared by the file sharing software 401. Such a storage 403 would typically be a directory on a hard disk. In some cases, the storage 403 may contain a separate portion in which downloaded multimedia objects are stored. This portion, typically also a directory, is not necessarily the same as the directory in which multimedia objects to be shared are stored.

A tracking module 404 in the file sharing client 101 monitors the number of times that individual multimedia objects are transmitted to other clients 102-105 on the file sharing network 100. This information can be stored on the storage 403, preferably in an encrypted format so that the operator of device 101 cannot tamper with the numbers. The information is then transmitted, using the networking module 402, to the accounting server 230 regularly, for example every day, or every time at least a certain number of multimedia objects have been shared.

It is also possible to notify the accounting server 230 separately every time a particular multimedia object is being transmitted to another client 102-105. This even more reduces opportunities for the operator to tamper with the results.

A watermarking module 405 is provided which detects a watermark present in the particular multimedia object 212 when it is downloaded by the file sharing software 401. The watermarking module 405 then extracts the identifier, which it forwards to the accounting server 230 using the networking module 402.

Optionally, a fingerprinting module 406 can also be provided. This module 406 can generate a so-called robust fingerprint for the objects received from the file sharing network 100 and/or from objects obtained from other sources, such as directly from server 201.

There are several techniques that can be used to compute such a robust fingerprint. European patent application 01200505.4 (attorney docket PHNL010110) describes a method that generates robust fingerprints for multimedia objects such as, for example, audio clips. The audio clip is divided in successive (preferably overlapping) time intervals. For each time interval, the frequency spectrum is divided in bands. A robust property of each band (e.g. energy) is computed and represented by a respective fingerprint bit.

A multimedia object is thus represented by a fingerprint comprising a concatenation of binary values, one for each time interval. The fingerprint does not need to be computed over the whole multimedia object, but can be computed when a portion of a certain length, typically about three seconds, has been received. There can thus be plural fingerprints for one multimedia object, depending on which portion is used to compute the fingerprint over. For reasons of clarity, the term “the fingerprint” will be used even in cases when multiple fingerprints for one multimedia object can exist.

If subsequently a query is received comprising a fingerprint, this fingerprint can be compared against the fingerprints computed previously by the fingerprinting module 406. If a match is found, the client 101 determines that it has the requested multimedia object available in storage 403, and reports this fact back to the server 201 or to the node from which it received the query. It can then distribute the requested multimedia objects to the client that requested it originally from the server 201, and receive the reward.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of distributing a multimedia object (212) in which a client device (101) downloads the multimedia object (212) from a distributing server (201), whereby the client device (101) is connected to a peer-to-peer file sharing network (100) and redistributes the multimedia object (212) over the peer-to-peer file sharing network (100), for which redistributing the operator of the client device (101) is given a reward.

2. The method of claim 1, further comprising keeping track of the number of times that the client device (101) redistributes the multimedia object (212) over the peer-to-peer file sharing network (100), and rewarding the operator of the client device (101) in dependence on said number of times.

3. The method of claim 1, in which the reward constitutes at least one of a discount on a price normally paid for downloading a multimedia object from the distributing server (201), a number of points for use in a bonus system, an electronic coupon, a permission to download one or more further multimedia objects from the distributing server (201), metadata related to the multimedia object (212), and a ticket for an appearance of the performer(s) of the multimedia object (212).

4. The method of claim 1, further comprising obtaining an identifier for the operator of the client device (101) before distributing the multimedia object (212) and embedding the identifier in the multimedia object (212) by means of a watermark before the client device (101) downloads the multimedia object (212).

5. A method of enabling distribution of a multimedia object (212), comprising receiving a request for the multimedia object (212) from a client device (101), forwarding the request to a file sharing network (100), receiving an indication from a node (102) in the file sharing network (100) indicating that the node (102) is able to distribute the multimedia object (212) to the client device (101), and rewarding an operator of the node (102) for said distributing.

6. The method of claim 5, further comprising authorizing the request before forwarding the request to the file sharing network (100).

7. The method of claim 6, in which authorizing comprises obtaining payment from an operator of the client device (101).

8. The method of claim 5, in which the request is forwarded by obtaining a fingerprint for the multimedia object (212) and submitting a query comprising the fingerprint to a node in the file sharing network (100).

9. A system (200) for enabling distribution of a multimedia object (212), comprising a distributing server (201) arranged for receiving a request for the multimedia object (212) from a client device (101) and for forwarding the request to a file sharing network (100), and an accounting server (110, 230) for receiving an indication from a node (102) in the file sharing network (100) indicating that the node (102) is able to distribute the multimedia object (212) to the client device (101), and rewarding an operator of the node (102) for said distributing.

10. A client device (101) for use in the system (200) of claim 9, comprising a tracking module (404) arranged for keeping track of the number of times that the client device (101) redistributes the particular multimedia object (212) over the peer-to-peer file sharing network (100), and for transmitting said number of times to an accounting server (110, 230).
